(19) United States
(12) Patent Application Publication
(10) Pub. No.: US 2026/0070541 A1
(43) Pub. Date: Mar. 12, 2026

(54) PARKING ASSISTANCE DEVICE

(71) Applicants: DENSO CORPORATION, Kariya-city (JP); J-QuAD DYNAMICS Inc., Tokyo (JP)

(72) Inventor: Hiroki INAGAKI, Tokyo (JP)

(21) Appl. No.: 19/324,995

(22) Filed: Sep. 10, 2025

(30) Foreign Application Priority Data
Sep. 12, 2024 (JP) 2024-158186

(51) Int. Cl. B60W 30/06; B60W 30/18

(52) U.S. Cl. CPC B60W 30/06; B60W 30/18036; B60W 2420/403; B60W 2420/408; B60W 2420/54; B60W 2556/10

(57) ABSTRACT

A parking assistance device includes: an information acquiring unit configured to acquire surrounding condition information from a sensor; a parking area determining unit configured to determine, in a front position or in an approach route reaching the front position, whether a target parking area is a specific parking area; a turn-around area specifying unit configured to specify turn-around areas in an area containing the approach route using the surrounding condition information, in response to the target parking area being determined as the specific parking area; an operation assisting unit configured to assist a first operation as an operation of a vehicle for reaching the turn-around area; and a parking assisting unit configured to assist a reversing operation of the vehicle using the turn-around area and parks the vehicle having changed in the direction into the target parking area.

### CROSS-REFERENCE TO RELATED APPLICATION

This application is based on and claims the benefit of priority from earlier Japanese Patent Application No. 2024-158186 filed September 12, 2024, the description of which is incorporated herein by reference.

### BACKGROUND

### Technical Field

The present disclosure relates to a parking assistance device.

### Related Art

There is known a parking assistance device that assists parking of a vehicle in a parking lot. As a travel road (road) in a parking lot, a travel road which comes to a dead-end at one end by a wall, a fence, or the like is provided in some cases. The known parking assistance device previously stores a combination of a backward movement start position and a final parking position, specifies a backward movement start position from an image captured by an on-vehicle camera, and automatically drives a vehicle to perform a prescribed turning operation while moving backward from such a position toward the stored final parking position.

### BRIEF DESCRIPTION OF THE DRAWINGS

In the accompanying drawings:

FIG. 1 is a block diagram illustrating a configuration of a parking assistance device as an embodiment of the present disclosure;

FIG. 2 is an explanatory diagram illustrating an example of a parking lot and an approach route set in the parking lot;

FIG. 3 is a flowchart illustrating a procedure of a parking assisting process of a first embodiment;

FIG. 4 is an explanatory diagram illustrating an example of a turn-around area;

FIG. 5 is an explanatory diagram schematically illustrating a movement route example of a subject vehicle when S140 to S150 are performed in the first embodiment;

FIG. 6 is a block diagram illustrating a configuration of a parking assistance device of a second embodiment; and

FIG. 7 is a flowchart illustrating a procedure of a parking assisting process of the second embodiment.

### DESCRIPTION OF SPECIFIC EMBODIMENTS

In the above known parking assistance device, as disclosed in JP 2015-525207 A, a parking operation is performed along the previously stored combination of a backward movement start position and a final parking position like in other roads, even in a road which comes to a dead-end at one end. However, in a configuration in which a parking area is located near a wall or the like constituting a dead-end, the parking assistance of JP 2015-525207 A may fail to assist parking because there may not be sufficient space for a combination of the previously stored combination of a backward movement start position and a final parking position. For example, when a distance from a final parking position to a wall or the like is short, a forward operation to a position planned as the backward movement start position beyond the final parking position may not be able to be performed, thus failing to perform parking assistance. Therefore, there is demand for a technology in which a parking operation can be assisted when a target parking area is positioned in an environment where a forward operation of equal to or more than a predetermined threshold distance needed as a part of the parking operation cannot be performed.

According to an aspect of the present disclosure, there is provided a parking assistance device for assisting parking of a vehicle. This parking assistance device includes: an information acquiring unit configured to acquire surrounding condition information indicating a surrounding condition of the vehicle from a sensor that is mounted to the vehicle to detect the surrounding condition; a parking area determining unit configured to determine, in a front position of the parking area or in an approach route reaching the front position, whether a target parking area that is a parking area to serve as a parking target of the vehicle is a specific parking area that is a parking area positioned in an environment where the vehicle cannot perform a forward operation of equal to or more than a predetermined threshold distance needed as a part of a parking operation in a state in which the vehicle is positioned in the front position; a turn-around area specifying unit configured to specify a turn-around area that is a free area available for performing a reversing operation of changing a direction of the vehicle, in an area containing the approach route, using the surrounding condition information, in response to the target parking area being determined as the specific parking area; an operation assisting unit configured to assist a first operation as an operation of the vehicle for reaching the turn-around area; and a parking assisting unit configured to assist the reversing operation of the vehicle using the turn-around area and parks the vehicle having changed in the direction into the target parking area.

According to the parking assistance device of this aspect, in response to the target parking area being determined as the specific parking area, the turn-around area that is a free area available for performing a reversing operation of changing a direction of the vehicle is specified, in an area containing the approach route, using the surrounding condition information, the first operation of the vehicle to the turn-around area is assisted, the reversing operation of the vehicle using the turn-around area is assisted, and the vehicle having changed in the direction is parked into the target parking area. Therefore, the parking operation can be assisted when the target parking area is positioned in the environment where a forward operation of equal to or more than a predetermined threshold distance needed as a part of the parking operation cannot be performed.

### A. First Embodiment

### A1. Device Configuration

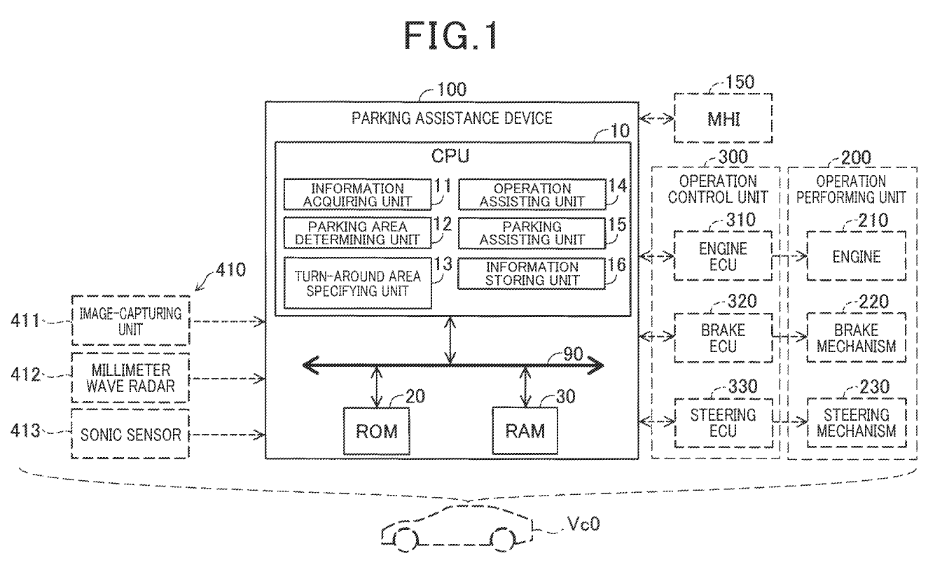

A parking assistance device 100 according to a first embodiment illustrated in FIG. 1 is mounted to a vehicle Vc0 and assists parking of the vehicle Vc0. The vehicle Vc0 can perform both of autonomous driving and manual driving. The autonomous driving refers to driving in a state in which basic operations such as running, turning, and stopping of the vehicle Vc0 as well as at least a part of various processes such as turning on lights or operating wipers are controlled by the parking assistance device 100 and unillustrated other control devices. On the other hand, the manual driving refers to driving in a state in which any of the above-described basic operations is controlled by a passenger of the vehicle Vc0. As illustrated in FIG. 1, the vehicle Vc0 includes, in addition to the parking assistance device 100, a sensor 410, a man-machine interface unit 150 (hereinafter, referred to as “MHI unit 150”), an operation performing unit 200, and an operation control unit 300. The parking assistance device 100 can communicate with the sensor 410, the MHI unit 150, and the operation control unit 300 via an on-board network. Examples of the on-board network to be used include controller area network (CAN), local interconnect network (LIN), FlexRay, and Ethernet (registered trademark).

The sensor 410 detects the surrounding condition of the vehicle Vc0. The sensor 410 transmits the detection result to the parking assistance device 100. In the present embodiment, the sensor 410 includes an image capturing unit 411, a millimeter wave radar 412, and a sonic sensor 413. The image capturing unit 411 captures an image of the surrounding of the vehicle Vc0 to obtain a captured image. The millimeter wave radar 412 and the sonic sensor 413 emit a millimeter wave or a sound wave and receives a reflected wave reflected by an object existing in the surrounding of the vehicle Vc0 to detect the position of such an object and the distance to such an object. Note that the “object” detected by the millimeter wave radar 412 is an aggregate of multiple detection points (targets).

The MHI unit 150 includes an unillustrated display device and an operation panel for the passenger to operate the vehicle Vc0, and communicates information between the parking assistance device 100 and the passenger. The MHI unit 150 may be realized by, for example, a touch panel type liquid crystal display. Using the MHI unit 150, the passenger can select various process menus or designate a parking area (hereinafter, referred to as “target parking area”) as a parking target among parking available areas detected by the sensor 410 and displayed on the unillustrated display device.

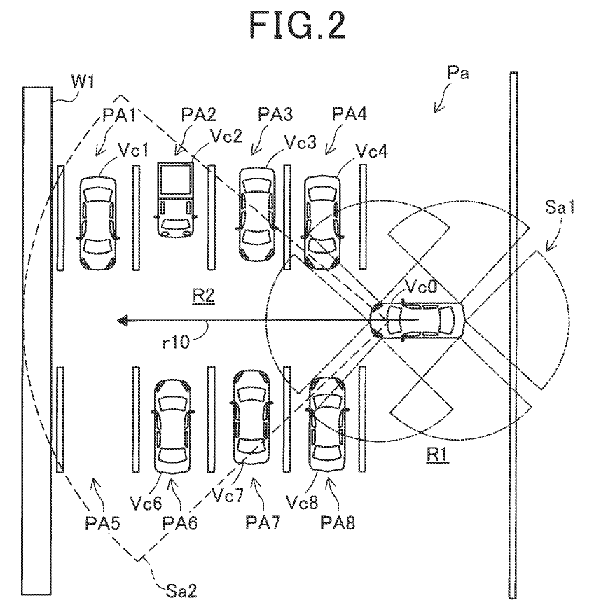

For example, as illustrated in FIG. 2, the passenger turns left from a travel road R1 to a travel road R2 in a parking lot Pa, stops the vehicle Vc0 there, and selects a menu for automatic parking using the MHI unit 150, so that an available parking area is detected in a detection range Sa1 by the millimeter wave radar 412 and the sonic sensor 413 and a detection range Sa2 by the image capturing unit 411. In the example of FIG. 2, vehicles have been already parked in seven parking areas excluding a parking area PA5 among eight parking areas PA1, PA2, PA3, PA4, PA5, PA6, PA7, and PA8. Specifically, a vehicle Vc1 is parked in the parking area PA1. Further, a vehicle Vc2, a vehicle Vc3, a vehicle Vc4, a vehicle Vc6, a vehicle Vc7, and a vehicle Vc8 are parked in the parking area PA2, the parking area PA3, the parking area PA4, the parking area PA6, the parking area PA7, and the parking area PA8, respectively. Therefore, only the parking area PA5 is detected as the parking available area in this case. In response to the passenger designating this parking area PA5 as the target parking area, a later-described parking assisting process is performed. Here, the travel road R2 comes to an dead-end at one end by a wall W1. The parking area PA5 is positioned near the wall W1. Therefore, the vehicle Vc0 cannot perform a forward operation any further even if it moves to the front of the parking area PA5. Even in such a case, the vehicle Vc0 can be parked in a state of having been moved backward in the parking area PA5 by performing the later-described parking assisting process. The “parked in a state of having been moved backward” means parking in a state in which the front side of the vehicle Vc0 is positioned at a side closer to the entrance of the parking area, while the back side of the vehicle Vc0 is positioned at a side farther from the entrance of the parking area. Hereinafter, the vehicle Vc0 is also referred to as “subject vehicle Vc0”.

The parking assistance device 100 illustrated in FIG. 1 is configured as a computer having a configuration in which a CPU 10, a ROM 20, and a RAM 30 can communicate with one another via an internal bus 90. The ROM 20 may be configured by, for example, a rewritable nonvolatile memory such as an EEPROM. The CPU 10 expands a computer program previously stored in the ROM 20 to the RAM 30 for executing the computer program, thereby to function as an information acquiring unit 11, a parking area determining unit 12, a turn-around area specifying unit 13, an operation assisting unit 14, a parking assisting unit 15, and an information storing unit 16.

The information acquiring unit 11 acquires, from the sensor 410, information (hereinafter, referred to as “surrounding condition information”) indicating the surrounding condition of the subject vehicle Vc0. The surrounding condition information corresponds to natural and manmade features detected by the sensor 410, such as the positions of other vehicles Vc1 to Vc4 and Vc6 to Vc8, the positions of division lines indicating the parking areas PA1 to PA8, and the position of the wall W1, which are illustrated in FIG. 2.

The parking area determining unit 12 determines whether the target parking area designated by the passenger is a specific parking area. The “specific parking area” means a parking area in which the target parking area is positioned in an environment where the subject vehicle Vc0 cannot perform a forward operation of equal to or more than a predetermined threshold distance needed as a part of a parking operation in a state in which the subject vehicle Vc0 is positioned in the front position of the parking area. The above-described “threshold distance” is 3 m (meters) in the present embodiment. However, the threshold distance is not limited to 3 m, and may be an optional distance which allows a steering operation such that the direction of the subject vehicle Vc0 follows the front-back direction of the target parking area in order to move backward and enter the target parking area. Such a threshold distance may be decided by the size, minimum turning radius, or the like of the subject vehicle Vc0. For example, the parking area PA5 in FIG. 2 is a parking area positioned in an environment where the subject vehicle Vc0 cannot perform a forward operation of the threshold distance or more toward the wall W1 direction as a part of the parking operation (operation of parking while moving backward) in a state in which the vehicle Vc0 is positioned in the front position of the parking area PA5 because of the existence of the wall W1 as described above. The parking area determining unit 12 can detect the position of the wall W1 and the position of the parking area PA5 from the detection result of the sensor 410 to determine from these positions that the parking area PA5 is the specific parking area.

In response to the target parking area being determined as the specific parking area, the turn-around area specifying unit 13 uses the surrounding condition information to specify a free area (hereinafter, referred to as “turn-around area”) that is available for performing an operation (hereinafter, referred to as “reversing operation”) of changing the direction of the subject vehicle Vc0 in an area containing an approach route. The “approach route” means a route from the current position of the vehicle Vc0 to the front position of the target parking area. Details of the turn-around area will be described later.

The operation assisting unit 14 assists an operation (hereinafter, referred to as “first operation”) of the subject vehicle Vc0 for reaching the turn-around area. Specifically, the operation assisting unit 14 instructs the operation control unit 300 to move the subject vehicle Vc0 by autonomous driving such that the subject vehicle Vc0 reaches the turn-around area.

The parking assisting unit 15 parks the vehicle Vc0 into the target parking area by autonomous driving. For example, the parking assisting unit 15 assists the reversing operation of the subject vehicle Vc0 using the turn-around area and parks the subject vehicle Vc0 having reversed in the direction into the target parking area.

The information storing unit 16 stores, in the ROM 20, information (hereinafter, referred to as “track information”) indicating the track of the movement of the subject vehicle Vc0 and information (hereinafter, referred to as “operation history information”) indicating the operation history of an actuator which causes an operation of the subject vehicle Vc0. The above-described actuator means various actuators contained in the operation performing unit 200. The “operation history information” may be information indicating the history of a command value notified from the operation control unit 300 to the operation performing unit 200.

### A2. Parking Assisting Process

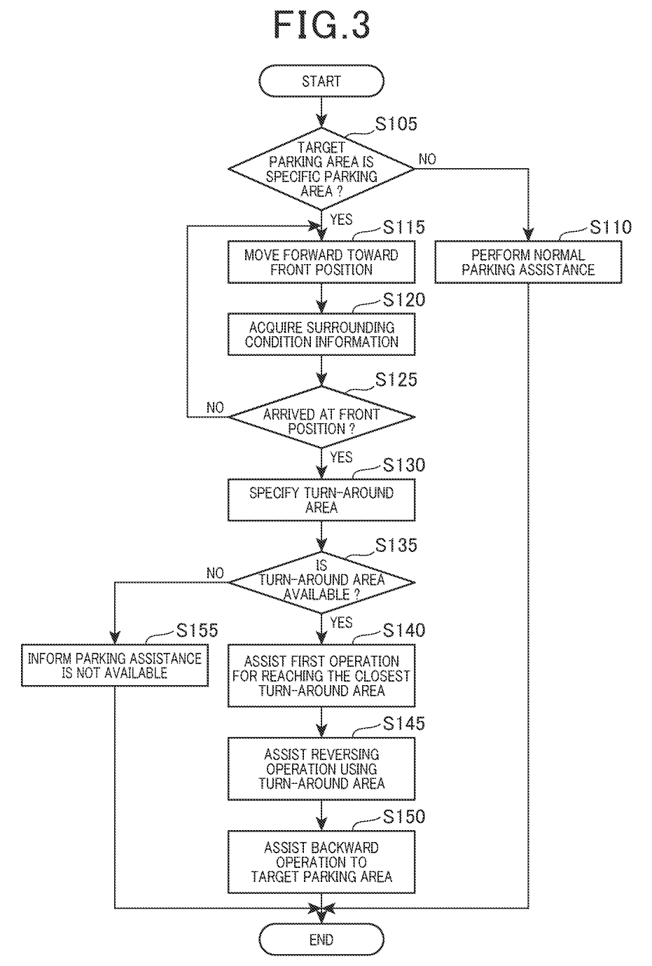

As described above, a parking assisting process illustrated in FIG. 3 is performed in response to the passenger of the vehicle Vc0 designating the target parking area using the MHI unit 150. In step S105, the parking area determining unit 12 determines whether the target parking area is the specific parking area. Hereinafter, “step S” is simply described as “S”. In response to the target parking area being determined not to be the specific parking area (S105: NO), the parking assisting unit 15 performs normal parking assistance in S110. The “normal parking assistance” means to cause the subject vehicle Vc0 to perform a predetermined operation as an operation for being parked into the target parking area in a state of having been moved backward. Specifically, for example, if there is no parked vehicle in the parking area PA8 illustrated in FIG. 2, and the parking area PA8 is designated as the target parking area, the parking area PA8 is determined not to be the specific parking area. In this case, the parking assisting unit 15 moves the subject vehicle Vc0 to a position forward than the threshold distance from the front position of the parking area PA8 and stops the subject vehicle Vc0 there, and then moves the subject vehicle Vc0 backward while steering it to the parking area PA8 which is the target parking area. After completion of S110, the parking assisting process ends.

As illustrated in FIG. 3, in response to the target parking area being determined as the specific parking area (S105: YES), the parking assisting unit 15 controls the operation control unit 300 to move the subject vehicle Vc0 forward toward the front position of the target parking area in S115. In S120, the information acquiring unit 11 acquires surrounding condition information. Here, S120 is performed concurrently with S115. That is, the surrounding condition information detected by the sensor 410 is acquired while the subject vehicle Vc0 moves forward toward the front position of the target parking area. In S125, the parking assisting unit 15 determines whether the subject vehicle Vc0 has reached the front position of the target parking area. In response to the subject vehicle Vc0 being determined not to have arrived at the front position of the target parking area (S120: NO), the process returns to the above-described S115. Therefore, the forward movement of the subject vehicle Vc0 is performed while acquiring surrounding condition information, until the subject vehicle Vc0 arrives at the front position of the parking area.

In response to the subject vehicle Vc0 being determined to have arrived at the front position of the target parking area (S125: YES), the turn-around area specifying unit 13 specifies the turn-around area in S130 and determines the present or absence of the turn-around area in S135.

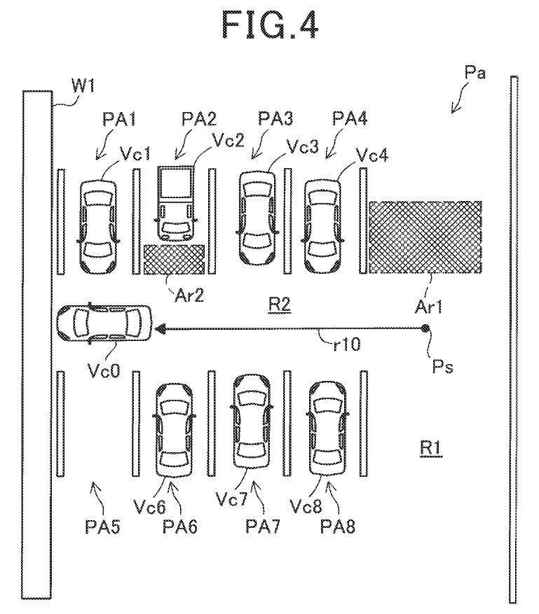

In the example of FIG. 4, the subject vehicle Vc0 moved forward along an approach route r10 from position ps at which the parking assisting process started to the front position of the parking area PA5 as the target parking area, and has arrived at such a front position. In this example, two rectangular areas are specified as turn-around areas Ar1 and Ar2. The turn-around area Ar1 is an area within the travel road R1 next to position ps and an area next to the parking area PA4. The turn-around area Ar2 is a free area in the front of the vehicle Vc2 in the parking area PA2. The turn-around area specifying unit 13, for example, refers to a predetermined table in order to specify these two areas Ar1 and Ar2 as the turn-around areas. Specifically, for an area available for parking the subject vehicle Vc0 into the target parking area in a state of having been moved backward by moving the subject vehicle Vc0 in a combination of backward movement, steering, and forward movement, a table may be previously prepared by specifying the relative position with respect to the target parking area and the size of the area through experiments, simulations, and the like, such that the table is referred to in S130 for specifying the turn-around area among free areas specified by the surrounding condition information. The “relative position with respect to the target parking area” in the table means, for example, the relative position coordinate of four corners of the rectangular free area with respect to a position representing the target parking area. The “position representing the target parking area” may be, for example, an optional position representing the target parking area, such as a position of the target parking area on the nearest side to the subject vehicle Vc0 travelling along the approach route or the barycentric position of the target parking area.

In response to the turn-around area being determined to be absent (S135: NO), the parking assisting unit 15 informs via the MHI unit 150 that parking assistance cannot be performed in S155, and the parking assisting process ends. On the other hand, in response to the turn-around area being determined to be present (S135: YES), the operation assisting unit 14 assists the first operation for reaching a turn-around area closest from the current position, i.e., from the front position of the target parking area in S140. In the example of FIG. 4, the first operation for reaching the turn-around area Ar2 which is closer among two turn-around areas Ar1 and Ar2 is assisted. At this time, the operation assisting unit 14 uses track information and operation history information stored in the information storing unit 16 to move the subject vehicle Vc0 (backward) along the approach route r10 to the turn-around area Ar2. For example, track history information can be used to realize the backward movement of the subject vehicle Vc0 along the approach route r10. Alternatively, for example, the operation history information of the actuator can be used to realize the backward movement of the subject vehicle Vc0 along the approach route r10 by specifying the steering angle and acceleration of the subject vehicle Vc0 at each position from the position of the turn-around area Ar2 to the front position of the target parking area during performance of S115 and running the subject vehicle Vc0 with a reverse steering angle and acceleration therefrom.

In S145, the parking assisting unit 15 assists the reversing operation of the subject vehicle Vc0 using the turn-around area. By performing S145, the direction of the subject vehicle Vc0 is changed. In S150, the parking assisting unit 15 assists the backward operation to the target parking area. After completion of the above-described S150 or S155, the parking assisting process ends.

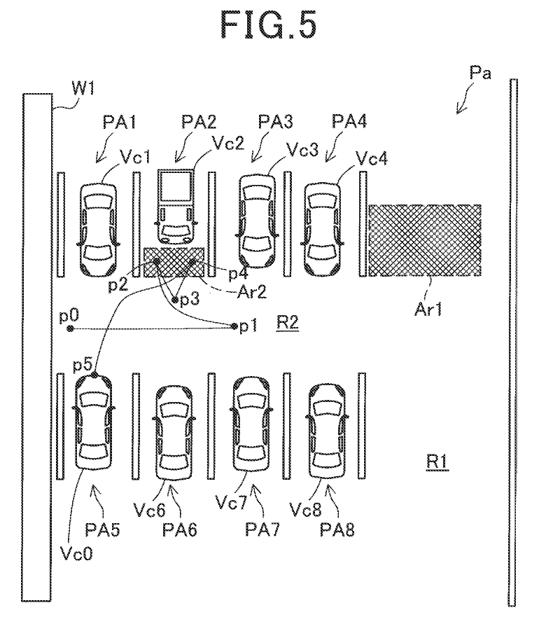

FIG. 5 illustrates the change of the position of the front edge of the subject vehicle Vc0 when S140 to S150 are performed, with positions p0 to p5. In the example of FIG. 5, the position of the front edge of the subject vehicle Vc0 is described as the position of the subject vehicle Vc0 for the convenience of illustration. In S140, the subject vehicle Vc0 moves from position p0 to position p1. The position p1 is a position predetermined as the relative position with respect to the turn-around area, as a starting point for performing the reversing operation using the turn-around area Ar2 specified as the closest turn-around area. In S145, the subject vehicle Vc0 moves from position p1 to positions p2, p3, and p4 in this order. In S150, the subject vehicle Vc0 moves from position p4 to position p5. In the present embodiment, an area closest from the front position of the target parking area is selected as the turn-around area used for actually performing the reversing operation, among the turn-around areas specified in S130, as described above. This is for reducing the size of the area needed in performing S140 to S150 by reducing the traveled distance of the subject vehicle Vc0 in performing S140 to S150 such that the possibility of the occurrence of a failure during performance of such an operation is reduced.

According to the parking assistance device 100 of the above-described embodiment, in response to the target parking area PA5 being determined as the specific parking area, the turn-around areas Ar1 and Ar2 that are each a free area available for performing a reversing operation of changing the direction of the subject vehicle Vc0 are specified in an area containing the approach route r10 using surrounding condition information, the first operation for reaching the turn-around area Ar2 is assisted, the reversing operation of the subject vehicle Vc0 using the turn-around area Ar2 is assisted, and the subject vehicle Vc0 having changed in the direction is parked into the target parking area PA5. Therefore, the parking operation of the subject vehicle Vc0 can be assisted when the target parking area PA5 is positioned in an environment where the forward operation of equal to or more than a predetermined threshold distance needed as a part of the parking operation cannot be performed.

Further, track information indicating the track of the movement of the subject vehicle Vc0 and operation history information of an actuator which causes an operation of the subject vehicle Vc0 are stored, and the track information and the operation history information are used to move the subject vehicle Vc0 along the approach route r10 to a position where the turn-around area Ar2 can be used in the first operation. Therefore, it is possible to precisely move the subject vehicle Vc0 along the approach route r10 to the position where the turn-around area Ar2 can be used in the first operation. The route along which the subject vehicle Vc0 travels in the first operation is a route along which the subject vehicle Vc0 has traveled once in S115, so that safety has been ensured. Therefore, the safety in the first operation can be enhanced.

Further, the operation assisting unit 14 assists the first operation for reaching the turn-around area Ar2 closest from the current position (the front position of the target parking area) in response to a plurality of turn-around areas Ar1 and Ar2 being specified in the area containing the approach route r10 by the turn-around area specifying unit 12. Therefore, the area needed from the first operation to the parking operation can be reduced in size compared to a configuration of assisting the first operation for reaching the turn-around area Ar1 farther from the current position. Therefore, the occurrence possibility of a failure during performance of these operations can be suppressed.

### B. Second Embodiment

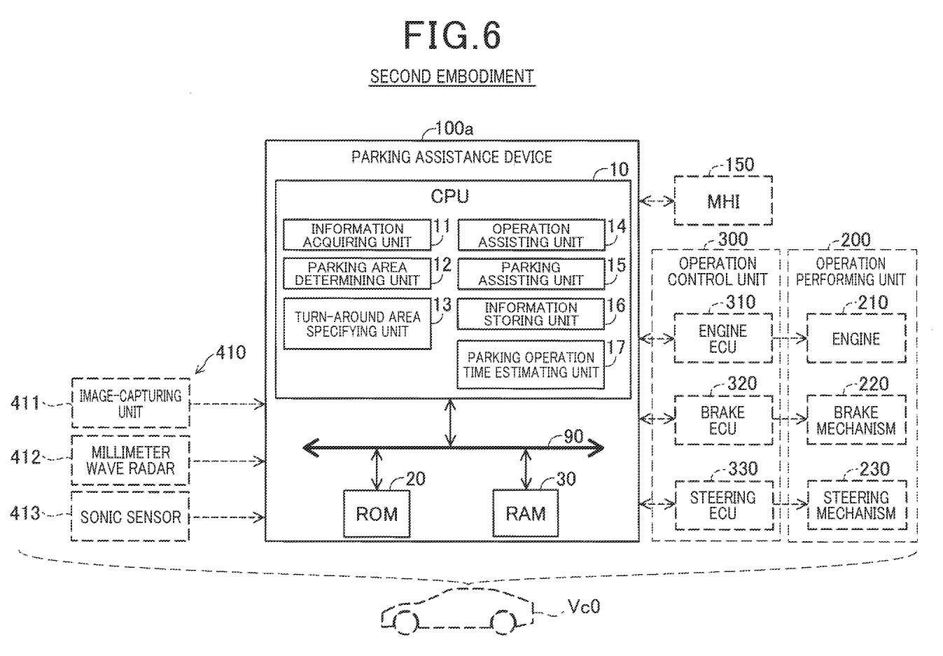

A parking assistance device 100a of a second embodiment illustrated in FIG. 6 differs from the parking assistance device 100 of the first embodiment only in that the CPU 10 also functions as a parking operation time estimating unit 17. A constituent in the parking assistance device 100a of the second embodiment which is the same as that in the parking assistance device 100 of the first embodiment is assigned with the same reference sign, and description thereof will be omitted.

The parking operation time estimating unit 17 estimates a parking operation time that is a time obtained by summing a time needed for the first operation from the front position of the target parking area to the position where the turn-around area can be used, a time needed for the reversing operation, and a time needed for parking the subject vehicle Vc0 having changed in the direction into the target parking area. The above-described “time needed for the first operation” may be specified as a time for reaching along the approach route r10 from the position where the turn-around area can be used to the front position of the target parking area in S115. The “time needed for the reversing operation” may be, for example, previously specified based on the position and size of the turn-around area through experiments and simulations to prepare a table. In general, the more the number of three-point turns, the longer the time needed for the reversing operation. The “time needed for parking the subject vehicle Vc0 having changed in the direction into the target parking area” may be, for example, previously specified according to the distance between the turn-around area and the target parking area through experiments and simulations to prepare a table.

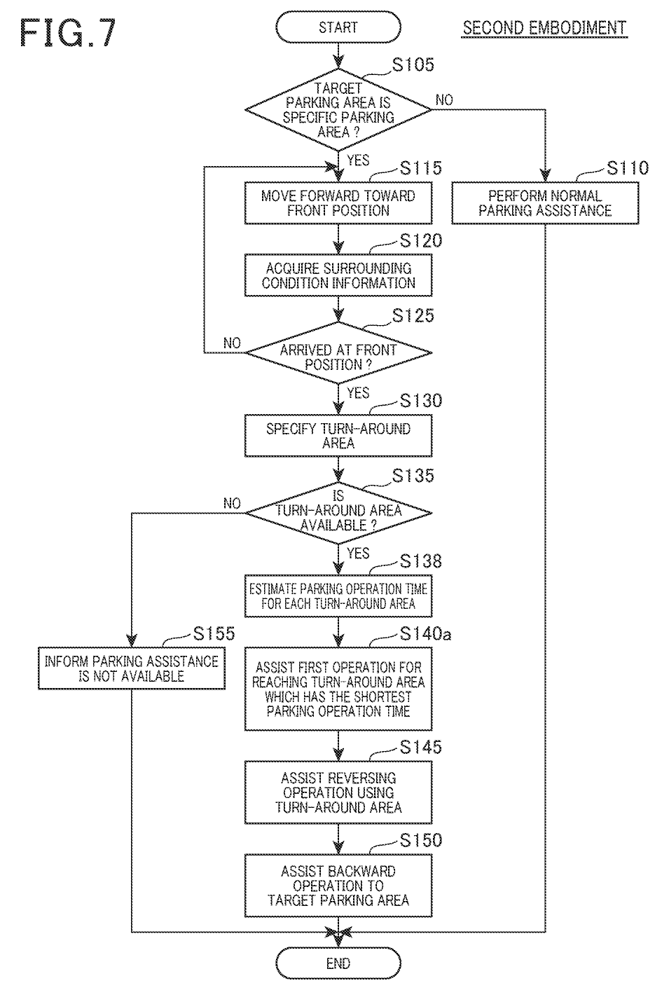

The parking assisting process of the second embodiment illustrated in FIG. 7 differs from the parking assisting process of the first embodiment in that S138 is performed after completion of S135 and in that S140a is performed instead of S140. Since other procedures in the parking assisting process of the second embodiment are the same as in the first embodiment, the same reference sign is assigned to the same procedure, and detailed description thereof will be omitted.

After completion of S135, the parking operation time estimating unit 17 estimates the parking operation time for each turn-around area specified in S130 (S138). For example, in the example of FIG. 5, the parking operation assistance time is estimated for each of two turn-around areas Ar1 and Ar2.

In S140a, the operation assisting unit 14 supports the first operation for reaching the turn-around area corresponding to the parking operation time that is shortest from the current position, i.e., from the front position of the target parking area. For example, in a configuration in which two or more reversing operations are performed in the reversing operation using the turn-around area Ar2 unlike in the example of FIG. 2, the parking operation time for the turn-around area Ar1 may be shorter because only one reversing operation is performed in the reversing operation using the turn-around area Ar1. In this case, the first operation of the subject vehicle Vc0 for reaching the turn-around area Ar1 comes to be assisted in S140a, unlike in the first embodiment.

The above-described parking assistance device 100a of the second embodiment exerts effects similar to those of the parking assistance device 100 of the first embodiment. Additionally, in response to a plurality of turn-around areas being specified in the area containing the approach route r10 by the turn-around area specifying unit 12, the operation assisting unit 14 assists the first operation for reaching the turn-around area Ar1 corresponding to the shortest parking operation time among the plurality of turn-around areas Ar1 and Ar2. Therefore, the time for parking the subject vehicle Vc0 can be shortened compared to a configuration of assisting the first operation for reaching the turn-around area Ar2 corresponding to a longer parking operation time.

Note that it may be configured that the first embodiment and the second embodiment described above are performed in combination. Specifically, for example, it may be configured that the passenger uses the MHI unit 150 to designate which of S140 and S140a is given priority to be performed. In such a configuration, only the process designated by the passenger may be performed.

### C. Other Embodiments

(C1) Although the information storing unit 16 stores both the track information and the operation history information in the ROM 20 in each of the above-described embodiments, the present disclosure is not limited thereto. The information storing unit 16 may store only one of the track information and the operation history information in the ROM 20. Even in such a configuration, the first operation for reaching the turn-around area can be assisted using information stored in the ROM 20 in S140 or S140a. Further, the information storing unit 16 may be omitted. In such a configuration, the first operation for reaching from the front position of the target parking area to the turn-around area may be performed while detecting the surrounding condition behind the subject vehicle Vc0 by the sensor 410.

(C2) Although one end of the travel road R2 comes to a dead-end due to the existence of the wall W1 in each of the above-described embodiments, a dead-end may be formed for an optional reason in place of the wall W1. For example, a dead-end may be formed for reasons such as because a fence or a Color Cone (registered trademark) is provided or because another vehicle is temporarily parked due to congestion.

(C3) Although S115 to S125 are performed until the subject vehicle Vc0 arrives at the front position of the target parking area in each of the above-described embodiments, the present disclosure is not limited thereto. The subject vehicle Vc0 may proceed while specifying the turn-around area in the approach route r10 reaching the front position of the target parking area, and S115 (forward operation) may be terminated in response to at least one turn-around area being specified. In such a configuration, the operation assisting unit 14 may assist the first operation for reaching from the current position of the subject vehicle Vc0, i.e., a point where the subject vehicle Vc0 stopped, to the specified turn-around area.

(C4) Although S115 is realized by the autonomous driving by the parking assisting unit 15 in each of the above-described embodiments, the present disclosure is not limited thereto. S115 may be realized by manual driving until the subject vehicle Vc0 reaches the front position of the target parking position. When the subject vehicle Vc0 arrives at the front position of the target parking position in such a configuration, the subject vehicle Vc0 may inform accordingly and switch from the manual driving to autonomous driving.

(C5) The parking assistance devices 100 and 100a and the methods therefor according to the present disclosure may be realized by a dedicated computer provided by configuring a processor programmed to implement one or more functions embodied by computer programs and a memory. Alternatively, the parking assistance devices 100 and 100a and the methods therefor according to the present disclosure may be realized by a dedicated computer provided by configuring a processor with one or more dedicated hardware logic circuits. Alternatively, the parking assistance devices 100 and 100a and the methods therefor according to the present disclosure may be realized by one or more dedicated computers configured by a combination of the processor programmed to implement one or more functions and a memory and the processer configured with one or more hardware logic circuits. The computer programs may be stored as an instruction to be executed by a computer in a computer-readable non-transitory tangible memory medium.

The present disclosure can also be realized in various aspects. For example, the present disclosure can be realized in aspects of a parking assistance method, a computer program for realizing a parking assistance device and a parking assistance method, and a non-temporary memory medium storing such a computer program.

The present disclosure is not limited to the above-described embodiments, and can be realized in various configurations within the scope that does not depart from the spirit thereof. For example, technical features in embodiments corresponding to respective technical features in aspects described in Summary of the Invention can be appropriately replaced or combined in order to solve a part or the entirety of the above-described problems or in order to achieve a part or the entirety of the above-described effects. Further, the technical features can be appropriately deleted if not described as essential herein. The present disclosure can be realized in aspects such as a control method of a collision damage reducing function, a computer program for realizing such a method, and a non-temporary memory medium storing such a computer program.

What is claimed is:

1. A parking assistance device for assisting parking of a vehicle comprising:
an information acquiring unit configured to acquire surrounding condition information indicating a surrounding condition of the vehicle from a sensor that is mounted to the vehicle to detect the surrounding condition;
a parking area determining unit configured to determine, in a front position of the parking area or in an approach route reaching the front position, whether a target parking area that is a parking area to serve as a parking target of the vehicle is a specific parking area that is a parking area positioned in an environment where the vehicle cannot perform a forward operation of equal to or more than a predetermined threshold distance needed as a part of a parking operation in a state in which the vehicle is positioned in the front position;
a turn-around area specifying unit configured to specify a turn-around area that is a free area available for performing a reversing operation of changing a direction of the vehicle, in an area containing the approach route, using the surrounding condition information, in response to the target parking area being determined as the specific parking area;
an operation assisting unit configured to assist a first operation as an operation of the vehicle for reaching the turn-around area; and
a parking assisting unit configured to assist the reversing operation of the vehicle using the turn-around area and parks the vehicle having changed in the direction into the target parking area.

22 The parking assistance device according to claim 1, further comprising
an information storing unit configured to store at least one of track information indicating a track of movement of the vehicle and operation history information of an actuator which causes an operation of the vehicle,
wherein the operation assisting unit moves the vehicle to a position where the turn-around area can be used along the approach route, in the first operation, using at least one of the track information and the operation history information.

3. The parking assistance device according to claim 1,
wherein the operation assisting unit assists the first operation to the turn-around area closest from a current position of the vehicle, in response to a plurality of the turn-around areas being specified in the area containing the approach route by the turn-around area specifying unit.

4. The parking assistance device according to claim 2,
wherein the operation assisting unit assists the first operation to the turn-around area closest from a current position of the vehicle, in response to a plurality of the turn-around areas being specified in the area containing the approach route by the turn-around area specifying unit.

5. The parking assistance device according to claim 1, further comprising:
a parking operation time estimating unit configured to estimate a parking operation time as a time obtained by summing a time needed for the first operation, a time needed for the reversing operation, and a time needed for parking the subject vehicle having changed in the direction into the target parking area, wherein
the parking operation time estimating unit estimates the parking operation time for each of the turn-around areas, in response to a plurality of the turn-around areas being specified in the area containing the approach route by the turn-around area specifying unit, and
the operation assisting unit assists the first operation to the turn-around area corresponding to the shortest parking operation time, among a plurality of the turn-around areas, in response to a plurality of the turn-around areas being specified in the area containing the approach route by the turn-around area specifying unit.

6. The parking assistance device according to claim 2, further comprising:
a parking operation time estimating unit configured to estimate a parking operation time as a time obtained by summing a time needed for the first operation, a time needed for the reversing operation, and a time needed for parking the subject vehicle having changed in the direction into the target parking area, wherein
the parking operation time estimating unit estimates the parking operation time for each of the turn-around areas, in response to a plurality of the turn-around areas being specified in the area containing the approach route by the turn-around area specifying unit, and
the operation assisting unit assists the first operation to the turn-around area corresponding to the shortest parking operation time, among a plurality of the turn-around areas, in response to a plurality of the turn-around areas being specified in the area containing the approach route by the turn-around area specifying unit.

7. A program product comprising:
a non-transitory computer-readable medium;
instructions stored on the non-transitory computer-readable medium that, when executed by a processor, cause the processor to perform a parking assistance method for assisting parking of a vehicle, the parking assistance method comprising:
acquiring surrounding condition information indicating a surrounding condition of the vehicle from a sensor that is mounted to the vehicle to detect the surrounding condition;
determining, in a front position of the parking area or in an approach route reaching the front position, whether a target parking area that is a parking area to serve as a parking target of the vehicle is a specific parking area that is a parking area positioned in an environment where the vehicle cannot perform a forward operation of equal to or more than a predetermined threshold distance needed as a part of a parking operation in a state in which the vehicle is positioned in the front position;
specifying a turn-around area that is a free area available for performing a reversing operation of changing a direction of the vehicle, in an area containing the approach route, using the surrounding condition information, in response to the target parking area being determined as the specific parking area;
assisting a first operation as an operation of the vehicle for reaching the turn-around area; and
assisting the reversing operation of the vehicle using the turn-around area and parks the vehicle having changed in the direction into the target parking area.

8. A non-transitory computer-readable medium storing instructions that, when executed by a processor, cause the processor to perform a parking assistance method for assisting parking of a vehicle, the parking assistance method comprising:
acquiring surrounding condition information indicating a surrounding condition of the vehicle from a sensor that is mounted to the vehicle to detect the surrounding condition;
determining, in a front position of the parking area or in an approach route reaching the front position, whether a target parking area that is a parking area to serve as a parking target of the vehicle is a specific parking area that is a parking area positioned in an environment where the vehicle cannot perform a forward operation of equal to or more than a predetermined threshold distance needed as a part of a parking operation in a state in which the vehicle is positioned in the front position;
specifying a turn-around area that is a free area available for performing a reversing operation of changing a direction of the vehicle, in an area containing the approach route, using the surrounding condition information, in response to the target parking area being determined as the specific parking area;
assisting a first operation as an operation of the vehicle for reaching the turn-around area; and
assisting the reversing operation of the vehicle using the turn-around area and parks the vehicle having changed in the direction into the target parking area.
